(19) United States
(12) Patent Application Publication
(10) Pub. No.: US 2024/0266892 A1
(43) Pub. Date: Aug. 8, 2024

(54) Electricity Dynamo Machine

(71) Applicant: Roberto Urbina, Port St Lucie, FL (US)

(72) Inventor: Roberto Urbina, Port St Lucie, FL (US)

(21) Appl. No.: 18/106,943

(22) Filed: Feb. 7, 2023

(51) Int. Cl. H02K 1/27; H02K 1/02; H02K 1/04; H02K 99/00

(52) U.S. Cl. CPC H02K 1/27; H02K 1/02; H02K 1/04; H02K 99/10; H02K 2207/03

(57) ABSTRACT

A machine that employs discharge of a first battery to enable rotation of a magnetic tube within a wire coil to generate electricity is disclosed. Discharge of the battery may continue until a sensor signals a second battery to begin discharge to enable the magnetic tube to continue to rotate to generate electricity. A portion of the electricity which may be generated is directed to recharging the first battery. Another portion is directed to an electricity powered device.

### TECHNICAL FIELD

The present disclosure relates to electricity generation machines and methods.

### BACKGROUND

Scientific, commercial, medical, governmental, military, communications and industrial activities, as well as offices, businesses, schools, homes, and electric vehicles need electrical power to perform their functions. Many businesses have standby generators to address electrical interruptions. However, standby generators may require substantial time to address suddenly unavailable electrical power. This may cause damage or loss to operations. A need therefore exists for sources of on-demand electric power.

### SUMMARY

The disclosed machine relates to generating electricity. The machine includes a rotatable magnetic tube having a length and a longitudinal axis. The tube is positioned within one or more coils of an electrically conductive wire along the length of the tube. The magnetic tube has a first end and an opposite second end attached to an inner magnetic ring. The inner magnetic ring is positioned in an electromagnetic ring having a thickness. The first and the second ends of the tube are each positioned in support members. The magnetic tube is positioned in an electromagnetic ring having a thickness and permanent magnets arranged in alternating polarities in an insulating material. The insulating material may be an organic polymer such as polyethylene. Permanent magnets which may be employed include any one or more of neodymium magnets, ferrites and samarium-cobalt magnets. The number of coils of wire may equal the number of permanent magnets.

The tube has a first end attached to an inner magnetic ring and an opposite second end attached to a support member. The inner magnetic ring is positioned in an electromagnetic ring that has a thickness and the electromagnetic ring is configured to receive electricity from batteries such as rechargeable batteries. A first energizing battery source enables the magnetic tube to spin on the longitudinal axis of the tube to generate electricity in the electrically conductive wire and the electromagnetic ring is also configured to receive electricity from a second energizing battery source to enable the magnetic tube to spin on the longitudinal axis of the tube to produce generated electricity in the electrically conductive wire. The electromagnetic ring and the support members cooperate to enable the magnetic tube to spin around the longitudinal axis of the tube. The electromagnetic ring is configured to receive electricity from the first energizing battery and the ring also is configured to receive electricity from the second energizing battery. A controller is configured to receive generated electricity and to direct a portion of the generated electricity to one or more of electrically powered devices, a first battery and a second battery. A sensor is configured to monitor power levels of both the first and second batteries to send signals to the controller to direct a portion of the generated electricity to at least one of the first and second batteries while maintaining flow of electricity to an electrically powered device. The sensor may employ one or more battery level monitors. The permanent magnets may be arranged in the insulating material in alternating polarities.

### BRIEF DESCRIPTION OF THE DRAWINGS

FIG. 1 shows a schematic of the electricity generating component of an electricity dynamo machine.

FIG. 2 shows the magnetic tube of the electricity generating component having an insulating material and embedded permanent magnets.

FIG. 3 shows a schematic of the electricity dynamo machine including an electricity generating component, two batteries as a power source, a controller that controls the flow of electricity from the generating component to an external device and/or to the batteries, and a sensor that monitors the power levels of the batteries and sends signals to the controller regarding allocation of electricity to re-charge the batteries while maintaining flow of electricity to the external device.

### DETAILED DESCRIPTION

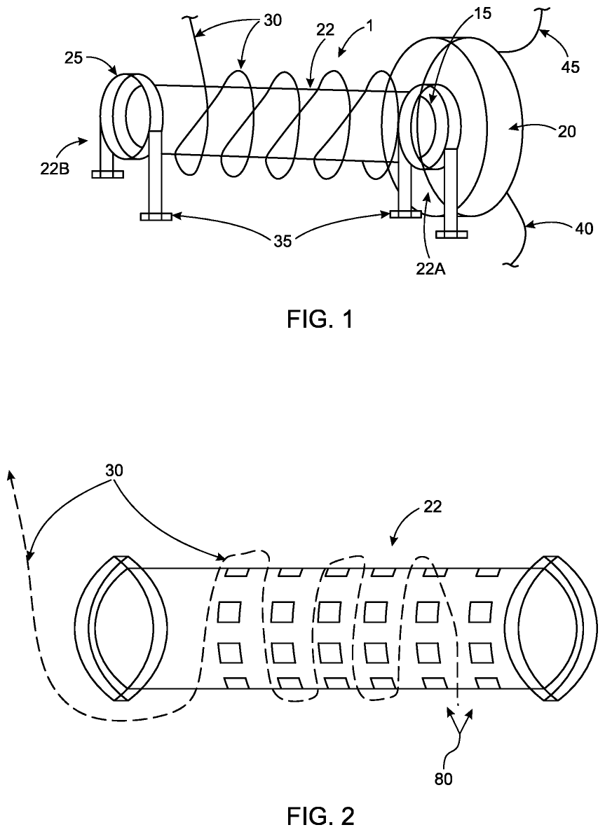

With reference to FIG. 1, the electricity generating component 1 of the electricity dynamo machine includes a magnetic tube 22. Magnetic tube 22 may be formed of a magnetic material. Suitable magnetic materials include but are not limited to ceramic magnetic materials such as ferrite, neodymium, and/or samarium-cobalt.

An inner magnetic ring 15 may be attached to a first end 22A of magnetic tube 22 and may be positioned in electromagnetic ring 20. A second opposite end 22B of tube 22 may be positioned in a holding ring 25. At least one wire 30 may be coiled around and along the length of tube 22. The number of coils formed by wire 30 around tube 22 may be determined by one skilled in the art in view of power required from the electricity generating component.

Each of the inner magnetic ring 15 and the second opposite end 22B of tube 22 in holding ring 25 is positioned in support frame members 35 so that tube 22 is free to rotate within the coils formed by wire 30 and the electromagnetic ring 20 around the tube's longitudinal axis. During operation, ring 15 receives power from energizing sources such as rechargeable batteries 50, 60 via power lines 40 and 45. The electricity generated by the electricity generating component maybe outputted via wire 30.

With reference to FIG. 2, magnetic tube 22 may include an insulating material such as an organic polymer such as polyethylene that has an even number of evenly spaced, alternating polarity embedded permanent magnets 80 on the exterior surface thereof. Suitable magnets include but are not limited to ferrites, neodymium magnets and samarium-cobalt magnets. Wire 30 may be coiled around and along the length of tube 22. The number of coils formed by wire 30 around tube 22 may equal the number of magnets in tube 22. Typically, tube 22 may have an even number of evenly spaced magnets.

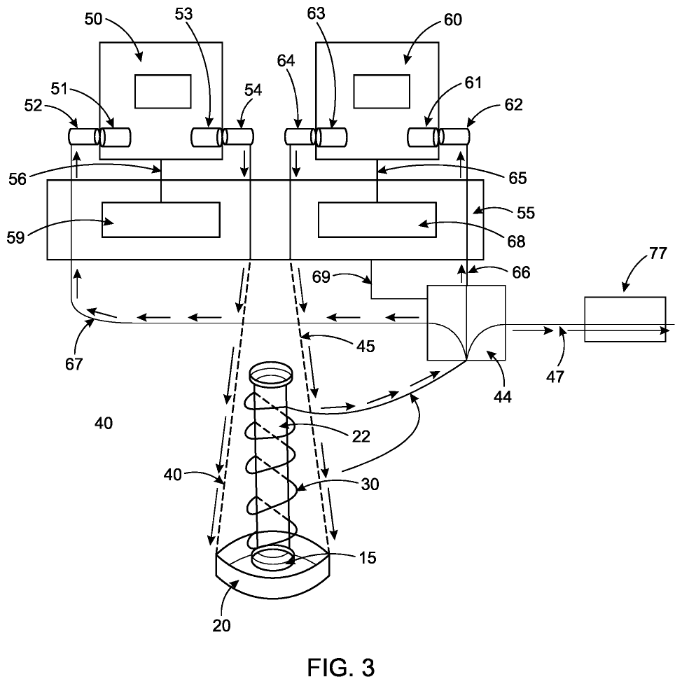

With reference to FIG. 3, power may be supplied to electromagnetic ring 20 from at least one of a first battery 50 and a second battery 60 via power line 40 and power line 45 respectively.

Electricity generating component 1 may be connected to controller 44 via wire 30. Controller 44 may control the flow of electricity from electricity dynamo machine to device 77 that may be connected to controller 44 via line 47.

Controller 44 may also be connected to each of re-charging posts 52 and 62 via lines 67 and 66 respectively wherein the posts are configured to recharge the batteries through re-charging ports 51 and 61 respectively. The machine includes one or more sensors 55 configured to monitor the power levels of first battery 50 and second battery 60 by battery level monitors 59 and 68 inside the sensor that are connected to the first and second batteries by lines 56 and 65 respectively. The monitors may be programmed to monitor the charge levels of first and second rechargeable batteries 50,60 while power from at least one battery is supplied to electromagnetic ring 20. Sensors 55 which may be employed may be software-based sensors such as those by TE Connectivity Ltd.

Sensors 55 may also be connected to controller 44 via line 69 and may send signals to controller 44 regarding the flow of the electricity. Controller 44 may change the flow of electricity in accordance with signals from sensor 55 to maintain or increase the power level of the batteries above predetermined, pre-set minimum power levels while providing a flow of electricity to device 77. To maintain or increase the power levels of the batteries, controller 44 may supply electricity to at least one of re-charging posts 52 and 62 via lines 67 and 66 respectively.

### Operation of Machine

In operation, a first battery supplies electricity to an electromagnetic ring 20 that may urge the magnetic cylinder to rotate. Rotation of the inner magnetic ring 15 of the cylinder may induce a fluctuating electrical current within one or more wires coiled around the length of the magnetic tube to generate electricity. The electricity may be transmitted by an electrical lead to a controller for apportioning generated electricity to charge a second battery and to supply an external device requiring electricity, for example, an electric vehicle, an utility power grid and the like. As the first battery discharges, the power level of the first battery falls to a predetermined, pre-set minimum power level setting. The minimum power level setting may vary according to battery type and capacity. Typically, the minimum power level setting for the first and second battery is about 20% of the full charge capacity of the battery.

When first battery 50 is supplying electricity to electromagnetic ring 20 via power line 40, power level monitor 59 may detect that first battery 50 has dropped to a pre-set minimum power setting. In response, sensor 55 may direct electricity from second battery 60 to electromagnetic ring 20 via power line 45. Sensor 55 may signal controller 44 that any additional generated electricity beyond an amount of electricity required for continuous power to device 77 be directed to charging post 52 attached to re-charging port 51 of battery 50.

Over time, the power level of second battery 60 may fall to pre-set minimum power setting. Power level monitor 68 may then signal the sensor 55 that second battery 60 has dropped to the minimum power setting. In response, sensor 55 may direct electricity from first battery 50 to electromagnetic ring 20 via power line 40. Sensor 55 may signal controller 44 that any additional generated electricity beyond electricity required by device 77 be redirected to charge second battery 60 via output line 66 to charging post 62 connected to re-charging port 61.

This sequence of alternate switching between batteries is repeated to enable continuous generation of electricity for a period of time without interruption due to discharge of the battery providing electricity to electromagnetic ring 20.

1: A machine for generating electricity comprising,
a magnetic tube having a longitudinal axis and wherein the tube comprises a magnetic material,
wherein the tube is positioned within one or more coils of an electrically conductive wire wherein the coils are positioned along the length of the tube,
the magnetic tube having a first end attached to an inner magnetic ring and an opposite second end wherein the inner magnetic ring is positioned ni an electromagnetic ring having a thickness, and wherein the first and the second ends of the tube are each positioned in a support member,
wherein the electromagnet ring and the support members cooperate to enable the magnetic tube to spin around the longitudinal axis of the magnetic tube, and
wherein the electromagnetic ring is configured to receive electricity from a first energizing battery source to enable the magnetic tube to spin on the longitudinal axis of the tube to generate electricity in the electrically conductive wire and
wherein the ring also is configured to receive electricity from a second energizing battery source to enable the magnetic tube to spin on the longitudinal axis of the tube to generate electricity in the electrically conductive wire, and
a controller configured to receive electricity generated by the magnetic tube,
wherein the controller is configured to direct a portion of the generated electricity to one or more of electrically powered devices, the first energizing battery source and the second energizing source and
a sensor configured to monitor power levels of both the first and second batteries energizing sources and also configured to send signals to the controller to direct a portion of the generated electricity to one of the first and second batteries energizing sources while maintaining a flow of electricity to the electrically powered device.

2: The machine of claim 1, wherein the magnetic material is at least one of ferrite, neodymium, and samarium-cobalt.

3: The machine of claim 1, wherein the magnetic tube comprises an insulating material having embedded therein a plurality of permanent magnets, wherein the permanent magnets are arranged in the insulating material in alternating polarities.

4: The machine of claim 3 wherein the insulating material is an organic polymer.

5: The machine of claim 4 wherein the insulating material is polyethylene.

6: The machine of claim 1 wherein the permanent magnets are any one or more of neodymium and samarium-cobalt.

7: The machine of claim 3 wherein the number of coils equals the number of permanent magnets.

8: The machine of claim 1 wherein the batteries are rechargeable batteries.

9: The machine of claim 1 wherein the sensor comprises one or more battery level monitors.

10: A machine for generating electricity comprising,
a rotatable magnetic tube having a length and a longitudinal axis wherein the tube is positioned within one or more coils of an electrically conductive wire along the length of the tube, the magnetic tube having a first end and an opposite second end attached to an inner magnetic ring, wherein the inner magnetic ring is positioned in an electromagnetic ring having a thickness, and wherein the first and the second ends of the tube are each positioned in support members,
wherein the magnetic tube is positioned in an electromagnetic ring having a thickness, wherein permanent magnets are arranged in alternating polarities in the insulating material,
the tube having a first end attached to an inner magnetic ring and an opposite second end attached to a support member wherein the inner magnetic ring is positioned in an electromagnetic ring having a thickness, wherein the electromagnetic ring is configured to receive electricity from a first energizing battery source to enable the magnetic tube to spin on the longitudinal axis of the tube to generate electricity in the electrically conductive wire and wherein the electromagnetic ring also is configured to receive electricity from a second energizing battery source to enable the magnetic tube to spin on the longitudinal axis of the tube to produce generated electricity in the electrically conductive wire, and
wherein the electromagnetic ring and the support members cooperate to enable the magnetic tube to spin around the longitudinal axis of the tube,
wherein the electromagnetic ring is configured to receive electricity from the first energizing battery and wherein the ring also is configured to receive electricity from the second energizing battery; and a controller configured to receive the generated electricity and to direct a portion of the generated electricity to one or more of electrically powered devices, the first battery and the second battery; and
a sensor configured to monitor power levels of both the first and second batteries and configured to send signals to the controller to direct a portion of the generated electricity to at least one of the first and second batteries while maintaining flow of electricity to the electrically powered device.

11: The machine of claim 10 wherein the insulating material is an organic polymer.

12: The machine of claim 11 wherein the polymer is polyethylene.

13: The machine of claim 12 wherein the permanent magnets are any one or more of neodymium and samarium-cobalt.

14: The machine of claim 10 wherein the number of coils equals the number of permanent magnets.
